(19) United States
(12) Patent Application Publication
(10) Pub. No.: US 2023/0383483 A1
(43) Pub. Date: Nov. 30, 2023

(54) METHOD FOR HEATING A SCREED OF A ROAD FINISHING MACHINE

(71) Applicant: JOSEPH VOEGELE AG, Ludwigshafen/Rhein (DE)

(72) Inventors: Johannes PONTIUS, Schmelz (DE); Bernhard ERDTMANN, Edingen Neckarhausen (DE)

(73) Assignee: JOSEPH VOEGELE AG, Ludwigshafen/Rhein (DE)

(21) Appl. No.: 18/202,021

(22) Filed: May 25, 2023

(30) Foreign Application Priority Data
May 25, 2022 (EP) 22175360.1

(51) Int. Cl. E01C 19/48

(52) U.S. Cl. CPC E01C 19/48; E01C 2301/10

(57) ABSTRACT

A method for heating a screed of a road finishing machine, the method including obtaining a predetermined time for putting the screed into operation; obtaining a start time for beginning the heating of the screed based on the predetermined time; and automatically heating the screed by energy supply to a heating means of the screed from an energy source from the start time.

### CROSS REFERENCE TO RELATED APPLICATIONS

This application claims foreign priority benefits under 35 U.S.C. § 119(a)-(d) to European patent application number EP 22175360.1, filed May 25, 2022, which is hereby incorporated by reference herein in its entirety.

### TECHNICAL FIELD

The present disclosure relates to a method for heating a screed of a road finishing machine, and to a road finishing machine comprising a screed and a control unit.

### BACKGROUND

Road finishing machines are sufficiently well-known from prior art. These usually comprise a screed that receives material for the road pavement to be applied from a material bunker of the road finishing machine or a material bunker associated with the road finishing machine and spreads this material onto the subsoil to be provided with a road pavement. To this end, the screed typically comprises one or several heating means (e.g., one or more electrical resistance heating elements which may be formed as removable heating coils or rods, one or more gas heating elements such as gas burners, or any other suitable heating element or elements) to heat the material or to keep it at a given temperature while it is being spread onto the subsoil, so that the road pavement can be reliably spread and pressed on.

To this end, the screed has to be heated to the working temperature before the road finishing machine is put into service, so that the material to be spread can be reliably heated to the desired temperature. This requires an at least partial putting into operation of the road finishing machine before the actual work with the road finishing can begin when the material for producing the road pavement is spread.

This requires an exact planning of the operation of the construction site, also taking into consideration changing conditions, which is a challenge for the operator of a road finishing machine, but also from an economical and ecological point of view.

Starting from the known prior art, the technical problem to be solved is thus to configure the heating of a screed of a road finishing machine more simply and/or ecologically more acceptable.

### SUMMARY

According to the disclosure, this is achieved by a method for heating a screed of a road finishing machine and a road finishing machine comprising a screed and a control unit.

The method according to the disclosure for heating a screed of a road finishing machine comprises the following steps:

obtaining a predetermined time for putting the screed into operation;

obtaining a start time for beginning the heating of the screed based on the predetermined time;

automatically heating the screed by energy supply to a heating means of the screed from an energy source from the start time.

The steps of obtaining the predetermined time and the start time, and the controlling of the automatic heating can basically be performed by a control unit associated with the screed, or generally a (central) control unit of the road finishing machine. The control unit can in particular be configured as a computer.

In particular, the predetermined time for putting the screed into operation can be supplied to the control unit via an input by an operator, and the control unit can then determine the start time for beginning to heat the screed by further internal processing. Here, other parameters, which are, for example, relevant for the operation of the screed, or environmental parameters can be taken into consideration. The predetermined time is to be understood here as the time at which the operation of the road finishing machine or the screed, respectively, can be started. This means that with reaching the predetermined time, the screed is preferably heated to the working temperature that is required for the normal operation of the screed.

The energy supply from the energy source can in particular consist in a supply of current to the heating means.

The start time of the heating lies, according to the disclosure, before the predetermined time of the putting into operation and is in particular selected such that with reaching the predetermined time for putting the screed into operation, the heating of the screed has just been completed.

This is in particular to be understood such that the start time is, based on the predetermined time, determined in such a way that the distance of time of the start time and the predetermined time is just long enough that the screed can be heated automatically from its temperature at the start time with the selected parameters for the heating of the screed from the original temperature at the start time to the target temperature or working temperature when the predetermined time is reached. It can also be provided for the start time to be selected such that the target temperature or working temperature of the screed is reached within a period of time of ±10 minutes or ±15 minutes, or ±30 minutes around the predetermined time.

Basically, in preferred embodiments, the method according to the disclosure permits a heating of the screed preferably such that a time interval where the screed is not actually in operation (that means spreads material onto the subsoil for producing a road pavement), but nevertheless is operated at the desired working temperature, is preferably short. Preferably, the screed reaches the working temperature at most 20 minutes, preferably at most 10 minutes, before the predetermined time. If the start time is selected such that the working temperature is reached within a period of time (such as, for example, 20 minutes or 10 minutes) before the predetermined time, this can also serve as a time buffer in order to compensate, for example, changing environmental conditions (for example sudden rain within the time interval between the start time and the predetermined time) which have a negative influence on the time required for heating the screed, and to ensure a reaching of the working temperature with the reaching of the predetermined time.

Thereby, energy is saved so that this method is ecologically and/or economically better acceptable.

At the same time, the operation of the screed can thus be facilitated for an operator since a previous planning of the heating does no longer have to be performed by the operator.

It can furthermore be provided for the energy source to be an accumulator connected with a primary drive of the road finishing machine, or a fuel cell connected with the primary drive of the road finishing machine, or the primary drive of the road finishing machine, or an external energy source connected with the road finishing machine, or to comprise the same.

In particular in embodiments of the road finishing machine as an electric vehicle or a vehicle driven in a hybrid manner, or a fuel cell vehicle, it can be provided for the connection of the energy source (that means the accumulator or the fuel cell) with the screed for energy supply to be accomplished without activating the primary drive. This means, by this, energy is directly utilized from the fuel cell or the accumulator as electric energy for warming up or heating the screed without energy being additionally consumed by the primary drive of the road finishing machine not used at this time. Since the conversion of energy stored in such energy sources is possible without the operation of the primary drive, these embodiments are ecologically and/or economically particularly advantageous. As an external energy source, for example, a connection of the screed or the heating means of the screed to an available public electricity supply grid can be used.

In one embodiment, the obtaining of the start time is furthermore accomplished based on a measured environmental parameter. The environmental parameter can here in particular comprise at least one of the ambient temperature, humidity, amount of precipitation per unit time, brightness.

With these embodiments, environmental influences that can have a negative or positive effect on the required time interval for heating the screed can be considered in the determination of the predetermined time. If, for example, the ambient temperatures are comparatively high (for example, above 25° C. or above 30° C.), less energy and/or less time for heating the screed is/are required, so that the start time can be determined at a shorter distance of time to the predetermined time. If the ambient temperature is lower (for example only 10° C. or below 0° C.), more time for heating the screed is required, so that the distance between the start time and the predetermined time can or has to be selected to be correspondingly longer.

The environmental parameters can be measured by corresponding sensors that can be connected with the screed and/or the road finishing machine. For example, a humidity sensor, rain sensor and/or temperature sensor (for example in the form of an electronic thermometer), as they are basically already known, can be utilized.

Furthermore, the obtaining of the start time can be effected based on a measured cooling parameter and/or heating parameter of the screed.

This embodiment can be combined with the previously mentioned embodiments for obtaining the start time based on measured environmental parameters, however, it can also be provided as an alternative to them.

The cooling parameter and/or the heating parameter can preferably be a single number or a single value by which, for example, parameters characterizing the heat transfer from the screed to the environment can be summarized in order to approximately determine the cooling behavior, but also the behavior when taking-up heat, and thus the warming behavior of the screed. With this embodiment, the behavior of the screed can be considered for the determination of the start time which can reliably ensure a heating of the screed until the predetermined time.

In particular, the measured cooling parameter can be determined by heating the screed to a predetermined test temperature and subsequently determining a parameter associated with a cooling of the screed, and/or the measured heating parameter can be determined by heating the screed to a predetermined test temperature and subsequently determining a parameter associated with the heating of the screed. By this method, the cooling parameter and/or heating parameter can be technically easily determined. Furthermore, with one single heating to the test temperature, both parameters can thus be determined which can minimize the occurrence of systematic and/or random errors when determining the cooling parameter and/or the heating parameter.

In one embodiment, the automatic heating is only activated by a control unit of the screed when the control unit receives a signal indicative of a positioning of a securing element. The control unit can be a separate control unit (for example a computer) which is only associated with the screed. The control unit, however, can also be the control unit of the road finishing machine.

One can thereby ensure that the environmental conditions for the heating of the screed correspond to certain requirements even if no operator is present, for example, that the screed is horizontal or that the screed is shielded from the environment by non-combustible material. This improves operational safety.

It can in particular be provided for the securing element to comprise a non-combustible material and/or a heat-insulating material. The use of non-combustible and in particular heat-insulating material below or around the screed can realize the warming-up or heating, respectively, of the screed in a safer way and simultaneously or alternatively be ecologically and economically better acceptable.

It can furthermore be provided that the obtaining of the predetermined time is accomplished based on an input at an operating element of the road finishing machine and/or based on an input of an input means connected with a control unit of the screed by a wireless connection. The user can in particular communicate the predetermined time via an application on a mobile terminal, such as a smartphone, to the road finishing machine or the control unit of the road finishing machine, for example via a wireless connection, such as the mobile internet (4G, LTE or the like), so that the control unit can then determine the start time based thereon. This permits the operator a facilitated control of the screed.

The road finishing machine according to the disclosure comprises a screed and a control unit, wherein, for heating the screed, the control unit is configured to:

obtain a predetermined time for putting the screed into operation;

obtain a start time for beginning the heating of the screed based on the predetermined time; and

automatically heat the screed by energy supply to a heating means of the screed from an energy source from the start time.

This road finishing machine can realize an economically and/or ecologically better acceptable heating of the screed and simultaneously provide an increased operating convenience for an operator.

It can furthermore be provided for the energy source to be an accumulator connected with a primary drive of the road finishing machine, or a fuel cell connected with the primary drive of the road finishing machine, or the primary drive of the road finishing machine, or an external energy source connected with the road finishing machine, or to comprise the same. The use of an accumulator or a fuel cell permits to supply energy to the heating means (for example current), without the primary drive having to be activated, which can also render the heating of the screed more efficient from economical and/or ecological points of view.

In one embodiment, the road finishing machine comprises a sensor for measuring an environmental parameter, and the control unit is configured to determine the start time based on the measured environmental parameter. The determination of the start time can thus be effected more reliably which can be advantageous in view of economical and/or ecological factors.

Furthermore, the control unit can be configured to determine the start time based on a cooling parameter of the screed stored in a memory of the control unit. Thereby, the thermal behavior of the screed can be accounted for which permits to carry out the heating of the screed in an energetically more efficient manner.

In one embodiment, the control unit is configured to only activate the heating of the screed when the control unit receives a signal indicative of a positioning of a securing element. The securing element can in particular comprise a non-combustible material and/or a heat-insulating material. Thereby, the heating of the screed can be carried out in an energetically advantageous manner, and it can simultaneously be designed more safely.

### BRIEF DESCRIPTION OF THE DRAWINGS

FIG. 1 shows a schematic view of a road finishing machine having a screed according to one embodiment;

FIG. 2 shows a flow chart of a method for heating a screed of a road finishing machine according to one embodiment; and

FIG. 3 shows a flow chart of a method for determining a cooling parameter of the screed according to one embodiment.

### DETAILED DESCRIPTION

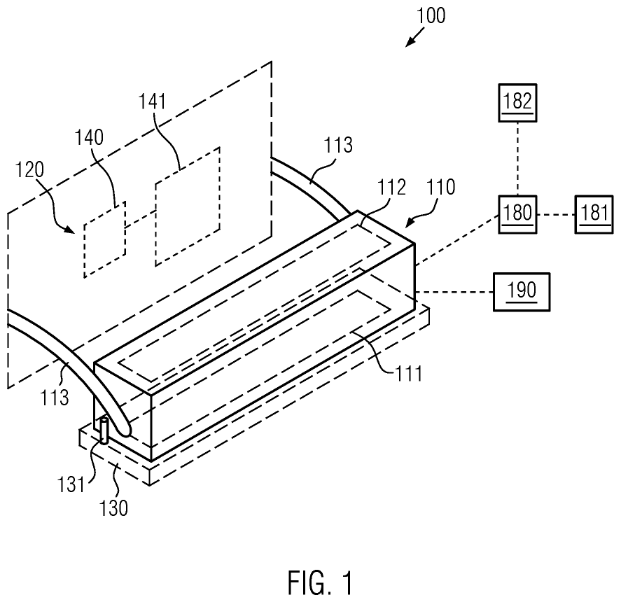

FIG. 1 shows a road finishing machine 100 having a screed 110 according to one embodiment of the disclosure. As is well-known, the road finishing machine 100 comprises a traction vehicle 120 or motor vehicle 120 to which a screed 110 is connected. The screed 110 can be connected to the traction vehicle 120, for example, via the connection elements 113 represented here, which can in particular be designed as levelling cylinders in order to compensate, for example, irregularities of the subsoil when spreading the road pavement by means of the screed 110. However, the connection elements 113 can also be designed as rigid connection elements.

The traction vehicle 120 usually comprises a primary drive 140. This primary drive can be designed, for example, as a combustion engine (diesel engine or gasoline engine). In alternative and preferred embodiments, the primary drive 140 can also be an electric motor or a hybrid drive or a fuel cell drive.

In case of an electric or hybrid primary drive or a fuel cell drive 140, an “energy source” 141 in the form of an accumulator or a fuel cell 141 can be provided which is connected with the primary drive 140, so that, for example, energy can be transferred from the accumulator or the fuel cell to the primary drive. In case of an accumulator, this is electric energy, so that the electric motor of the electric road finishing machine 100 or the electric motor of a road finishing machine 100 driven in a hybrid manner can be supplied with power as primary drive 140.

If the primary drive is designed as a combustion engine, the energy source can be designed as a tank for fuel (for example gasoline or diesel).

It can be provided for the energy source in the form of the fuel cell and/or the accumulator 141 to also be connected with a heating means 112 (e.g., one or more electrical resistance heating elements which may be formed as removable heating coils or rods, one or more gas heating elements such as gas burners, or any other suitable heating element or elements) of the screed 110, independent of the connection of the energy source with the primary drive 140, so that the heating means 112 of the screed 110 can preferably be supplied with energy without activation or energy supply to the primary drive 140. As an alternative, a connection of the heating means of the screed only with the primary drive 140 can be effected, so that the energy supply to the heating means of the screed is effected via the operation of the primary drive.

The heating means 112 can be used for heating, and also for operating the screed 110. To this end, the screed 110 can be heated by the heating means 112 initially to a desired temperature (hereinafter also the operating temperature). This can in particular also comprise the heating of a screed plate 111 of the screed 110. As is well-known, the screed plate 111 is used for uniformly distributing a road pavement spread onto the subsoil by pressing it on and heating it and applying it onto the subsoil. The heating means can heat this screed plate, but also further components of the screed to a desired operating temperature.

Here, it can be provided for a control unit 180 (for example in the form of a computer) to be associated with the screed 110 and/or the road finishing machine 100. The control unit 180 can comprise a memory 181 for data, or it can be associated with it. For example, this memory 181 can be designed as an internal hard disk of a computer that realizes the control unit 180. As an alternative or in addition, a memory 181 can also be realized in the form of a (changeable) non-volatile memory (for example a USB stick). Furthermore, an operating element 182, for example in the form of a keyboard or a touchscreen or a mobile terminal (for example a smartphone) connected with the control unit via a wireless connection, can be associated with the control unit 180 via which an operator of the control unit 180 can enter information.

As those skilled in the art will understand, the control unit 180, as well as any other controller, unit, component, module, system, subsystem, interface, keyboard, touchscreen, sensor, element, terminal, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, steps, functions and/or operations described herein, including interaction between and/or cooperation with each other. One or more of such processors, as well as other circuitry and/or hardware, may be included in a single Application-Specific Integrated Circuit (ASIC), or several processors and various circuitry and/or hardware may be distributed among several separate components, whether individually packaged or assembled into a System-on-a-Chip (SoC).

In the embodiment represented herein, a securing element 130 is furthermore shown. This securing element can be designed as a non-combustible element and/or as a heat-insulating element, or both, or comprise such elements, and can be positioned, for example, below a screed or (for example, if it is designed as a plurality of mats) preferably completely surround the screed, for example cover at least 50% or at least 80% of the outer surface of the screed. Thereby, in particular during a heating of the screed, it can be avoided that the screed and the environment catch fire which minimizes the risk of accidents.

If a heat-insulating material is furthermore used in the securing element or elements 130, heat emission from the screed to the environment at least through the securing elements 130 can be reduced or avoided, at least during a heating of the screed 110, which can reduce the energetic efficiency during the heating of the screed over the required time for heating the screed. As elements, here, for example, elements having a low coefficient of thermal conductivity, such as for example, rubber or polyurethane or foams, are possible. However, the embodiments are not restricted to these materials. Basically, any material or material combination that has heat-insulating properties and preferably a lower coefficient of thermal conductivity than the material of the screed can be used. Thus, layer structures which, for example, comprise ceramics and a further material can also be used.

In one embodiment, it can be provided for the control unit 180, that will be described hereinafter, to only perform the heating of the screed if the securing element or elements 130 is or are correctly positioned. To ensure this, it can be provided that a safety switch 130 is only automatically closed and/or can be (manually) closed if the securing element 130 is correctly positioned. The safety switch 131 can be designed, for example, as an electric or electronic switch which is closed if the securing element 130 is correctly positioned relative to the screed 110 (for example, by connecting a connection element of the securing element 130 with a connection element of the screed). Only then, the element 131 can transmit a corresponding electric or electronic signal to the control unit 180 which can then activate a heating of the screed based on this signal which is indicative of the correct positioning of a securing element 113 relative to the screed 110. The heating can then be caused corresponding to the following embodiments.

The road finishing machine can furthermore comprise at least one sensor 190 for measuring one or several environmental parameters. The sensor 190 can be designed, for example, as a sensor for measuring the ambient humidity, precipitation (rain or snow), brightness and/or temperature.

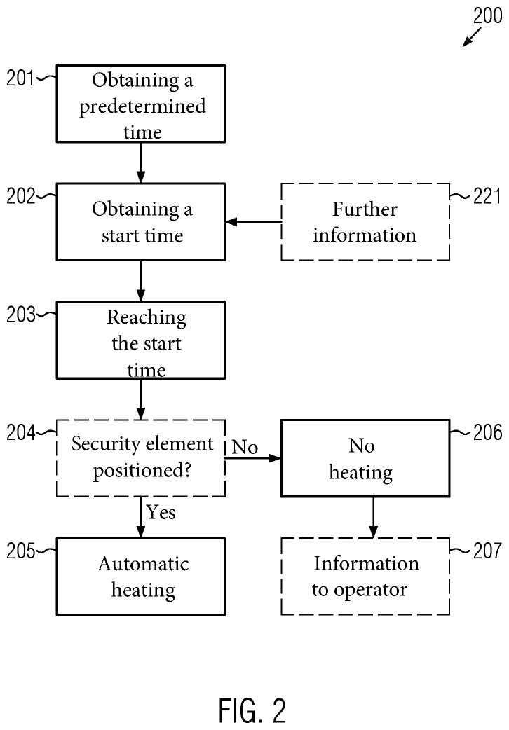

FIG. 2 shows a flow chart of a method for heating a screed according to one embodiment.

The method 200 corresponding to FIG. 2 starts with a first step 201 wherein the control unit 180 obtains a predetermined time at which the screed is to be warmed to a desired temperature or at which the screed is to be finally put into operation. Obtaining this predetermined time in step 201 can be also effected repeatedly, for example based on a time switch. For example, an operator can communicate once to the control unit that the screed is to be heated at certain times on certain days to the desired operating temperature to put the screed into operation. For example, the control unit can comprise information stored in the memory 181 according to which the screed has to be operable on workdays from Monday to Friday each as of 8 o'clock, that means that in particular the screed has to be heated to its operating temperature. That means that the heating of the screed has to be already completed at this time.

As an alternative or in addition, it can also be provided that an operator of the screed can enter the predetermined time into the control unit, for example by an input via an operating element 182 (for example a keyboard) which is associated with the control unit.

As an alternative or in addition, the control unit 180 can also receive the predetermined time, for example, via the input of the corresponding information on a mobile terminal, in particular a smartphone, as the operating element 182. In this case, a corresponding application or “app” can be stored in the mobile terminal (that means, for example, the smartphone) 182 which permits the remote access to the control unit 180 of the road finishing machine. This access can be realized, for example, via an encoded connection (VPN connection or the like), so that an unauthorized access to the control unit 180 of the road finishing machine is not possible.

Furthermore as an alternative or in addition, the control unit can obtain the predetermined time from a construction site management system associated with the road finishing machine or else integrated in the control unit 180. In the construction site management system, for example, information on the planned arrival of trucks with coated material can be stored on the construction site or the road finishing machine, or be retrievable via it. The control unit can then, for example, obtain the predetermined time as the planned arrival time of a next truck with coated material.

After the predetermined time has been obtained in step 201, the control unit can determine, in step 202, a start time for beginning with the heating of the screed based on the predetermined time obtained in step 201. In one embodiment, this can comprise that the start time is always set at a predetermined time interval before the predetermined time. Thus, the control unit can automatically fix the start time 30 minutes before the predetermined time, for example based on information stored in the memory 181. At this point in time, the heating of the screed can then be started, so that it can be brought to the desired operating temperature, for example, until the predetermined time is reached.

In other embodiments, further information 221 are also used in step 202 in order to determine the start time. The further information can be obtained, for example, via the sensor 190 of the road finishing machine. Thus, the sensor can measure the temperature and/or humidity and/or amount of precipitation and/or brightness, and from the environmental parameters obtained in this manner, the start time can also be determined taking into consideration the predetermined time. If, for example, the ambient temperature is comparably high (for example 30° or higher), the heating of the screed can be started at a later point in time (temporally not so far away from the predetermined time) than with an ambient temperature of −3° C. Moreover, information on humidity and/or precipitations as well as on brightness can be utilized in order to determine the start time based on the predetermined time and additionally taking into consideration these environmental parameters.

Furthermore, information of the construction site management system, as was already discussed for obtaining the predetermined time, can be utilized in order to reach the start time. Thus, the construction site management system can have weather information for the current time and/or for a future time period. The start time can be determined in particular based on the weather that is (probably) to be expected at the predetermined time (for example in the morning of the next day when the screed has to be put into operation again), and/or on a period of time before this, for example one hour or two hours or three hours before the predetermined time. If, for example, at the predetermined time and/or during an hour before the predetermined time, low temperatures (for example −3° C.) and/or precipitations are to be expected, the start time can be fixed to be earlier than in a case where higher temperatures and/or no precipitation is to be expected, so that more time for heating the screed is available.

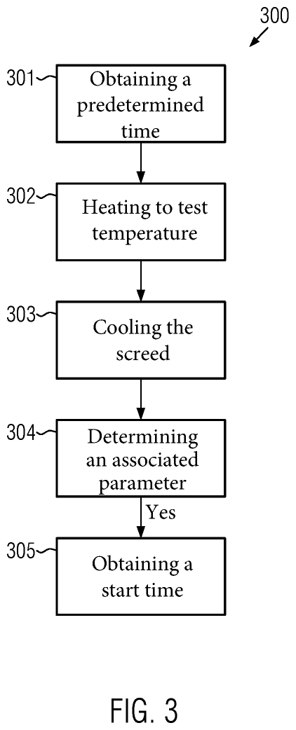

As an alternative or in addition, the start time can also be determined based on a cooling parameter of the screed, which can be determined, for example, based on the method described in FIG. 3.

After the start time has been obtained, it can be provided that no further automatic actions are carried out until the start time is reached. When the start time is reached in step 203, it can be, for example, checked whether the securing element described with reference to FIG. 1 is correctly positioned (step 204). This is only optional and is preferably only provided if a corresponding securing element 130 is also provided.

If the securing element is not correctly positioned, the control unit does not activate the heating of the screed as was already described with reference to FIG. 1. That means, there is no heating 206. Instead, corresponding information can optionally be transmitted, for example, to the application on the mobile terminal of the operator, or to a screen of the operating element 182, in step 207, so that the operator is informed that the heating of the screed has not been started.

Based on this information, which can be emitted, for example, as an optical or acoustic communication to the operator, the operator can then be instructed, for example, to correctly position the securing element. As an alternative or in addition, an option for authorizing the start of the heating of the road finishing machine even without the securing element being correctly positioned can be displayed to the operator. If the operator confirms this, the heating can be activated by the control unit although the securing element is not correctly positioned.

If the securing element is correctly positioned or if there is no verification in this respect in step 204, the automatic heating of the screed is subsequently effected by energy supply to the heating means, for example from the accumulator of the road finishing machine 141, as was already described with reference to FIG. 1.

FIG. 3 shows a further method 300 which can be carried out alternatively to steps 202 and 221, or in combination with them.

This method starts with step 301 in which a predetermined time is obtained at which the screed is to be heated to a desired operating temperature.

Subsequently, the screed is heated to a test temperature. This test temperature is preferably lower than the operating temperature of the screed and can comprise, for example, a heating starting from a current temperature of the screed by a certain number of kelvin which is independent of the operating temperature of the screed. For example, a heating of the screed by 10K or 20K or 30K can be effected. Other values are also conceivable as long as a reliable determination of the parameter associated with the cooling of the screed yet to be described in step 304 is possible. As an alternative, it can also be provided that the screed is heated to always the same test temperature which is also independent of the current temperature of the screed and/or the ambient temperature. This test temperature can be, for example, 60° C.

After the screed has been heated to the test temperature in step 302, the heating means of the screed is switched off, and a cooling of the screed is effected in step 303. This cooling will finally cause a cooling of the screed to the ambient temperature without the heating means being switched on again.

The cooling of the screed to ambient temperature, and in particular the time history of this cooling process, depends on physical parameters of the screed. In particular, the quantity of heat present in the screed at the test temperature T corresponds to Q=α·T, wherein T is the absolute temperature and α in general indicates the heat capacity of the screed (in J/K). In the most simple case, in which the screed consists exactly of one material that represents the total mass of the screed, α=c·m with c as the specific heat capacity and m as the mass of the screed would apply.

However, since the screed consists of different components and in particular different materials, the heat capacity a is in general more complicated, in particular a sum of the products of specific heat capacity and mass of the individual components of the screed. However, it has been found within the scope of the disclosure that it is not required for the heating of the screed to determine the contribution of each component of the screed to the heat capacity, but only the heat capacity of the screed altogether has to be determined.

Since the march of the temperature of the screed during the cooling depends on the time T(t) proportional to e^{-k(α)t}, T(t)=(T₀−Tᵤ)e^{-k(α)t}+Tᵤ (with T₀ as the test temperature and Tᵤ as the ambient temperature), one can conclude from the cooling behavior, and in particular the march of temperature over time, the physical properties of the screed, at least numerically. The parameter k(α) associated with the cooling can be determined in this manner. This is done in step 304, for example, after the march of temperature of the screed has been measured, for example by an internal temperature sensor which can be connected with the control unit. In step 304, from this measurement, either the parameter k(α) can be determined as a parameter of the screed associated with the cooling behavior (also referred to as cooling parameter), or the heat capacity a of the screed can be obtained from the parameter k(α). This can be done by additionally determining the emitted quantity of heat emitted from the screed during the cooling process.

Thus, the behavior of the screed during cooling, and in particular the temperature, can be measured at different times after the heating means has been switched off in order to subsequently numerically evaluate the above exponential course. For example, the temperature of the screed can be measured every 30 seconds over a period of 20 minutes after the heating means has been switched off at the end of step 302.

The parameter k(α) or a determined in step 304 in this way and associated with the cooling of the screed can subsequently be used in step 305 (for example, also in combination with further information, such as the ambient temperature and the operating temperature of the screed to be reached) in order to determine the start time also based on the time predetermined in step 301. The determination of the start time can basically also include, in all described embodiments, the power of the heating means since it fixes the quantity of heat per unit time that can be supplied to the screed.

This can be advantageously utilized in order to select the start time such that, with a given ambient temperature and operating temperature of the screed to be reached, the start time preferably lies only as long before the predetermined time that a heating of the screed to the operating temperature is achieved in the resulting time interval, preferably when the predetermined time is reached. And thereby, “idle times”, where the screed has been heated to the required operating temperature, but the predetermined time has not yet been reached, are avoided which is advantageous from ecological and economical points of view.

Instead of the determination of a parameter associated with the cooling based on the heating to the test temperature and the subsequent cooling in steps 302 and 303, it can also be provided that a parameter associated with the heating is determined with the method corresponding to FIG. 3. This can then also be utilized for obtaining the start time in step 305.

In this embodiment, a measurement, for example of the temperature of the screed, is effected during the heating to the test temperature in step 302. This can be measured, corresponding to the above description, for example every 30 seconds over the period of time during which the screed is heated from ambient temperature Tᵤ to the test temperature T₀. In this case, a parameter k(α) associated with the heating of the screed can then be analogously determined via the relation T(t)=(Tᵤ−T₀)e^{-k(α)t}+T₀ (with T₀ as the test temperature and Tᵤ as the ambient temperature). The parameter associated with the heating of the screed can also be understood as a heating parameter.

After the test temperature has been reached, in this embodiment, too, the heating means can be switched off and the screed can correspondingly cool again. It can also be provided that, corresponding to the embodiment of FIG. 3, in step 304, the cooling parameter is determined. It can furthermore be provided that both the cooling parameter and the heating parameter are utilized in step 305 for obtaining the start time. For example, the mean value from the determined cooling parameter and the determined heating parameter can be utilized to obtain the start time 305.

What is claimed is:

1. A method for heating a screed of a road finishing machine, the method comprising:
obtaining a predetermined time for putting the screed into operation;
obtaining a start time for beginning the heating of the screed based on the predetermined time; and
automatically heating the screed by energy supply to a heating means of the screed from an energy source from the start time.

2. The method according to claim 1, wherein the energy source comprises an accumulator connected with a primary drive of the road finishing machine, or a fuel cell connected with the primary drive of the road finishing machine, or the primary drive of the road finishing machine, or an external energy source connected with the road finishing machine.

3. The method according to claim 1, wherein the obtaining of the start time is based on a measured environmental parameter.

4. The method according to claim 3, wherein the environmental parameter comprises ambient temperature, humidity, amount of precipitation per unit time, or brightness.

5. The method according to claim 1, wherein the obtaining of the start time is based on a measured cooling parameter and/or a measured heating parameter of the screed.

6. The method according to claim 5, wherein the measured cooling parameter is determined by heating the screed to a predetermined test temperature and subsequently determining a parameter associated with a cooling of the screed, and/or wherein the measured heating parameter is determined by heating the screed to a predetermined test temperature and subsequently determining a parameter associated with the heating of the screed.

7. The method according to claim 1, wherein the automatic heating of the screed is only activated by a control unit if the control unit receives a signal indicative of a positioning of a securing element.

8. The method according to claim 7, wherein the securing element comprises a non-combustible material and/or a heat-insulating material.

9. The method according to claim 8, wherein the obtaining of the predetermined time is accomplished based on an input at an operating element of the road finishing machine, and/or based on an input of an input means connected with a control unit of the screed by a wireless connection.

10. A road finishing machine, comprising a screed and a control unit, wherein, for heating the screed, the control unit is configured to:
obtain a predetermined time for putting the screed into operation;
obtain a start time for beginning the heating of the screed based on the predetermined time; and
automatically heat the screed by energy supply to a heating means of the screed from an energy source from the start time.

11. The road finishing machine according to claim 10, wherein the energy source comprises an accumulator connected with a primary drive of the road finishing machine, or a fuel cell connected with the primary drive of the road finishing machine, or the primary drive of the road finishing machine, or an external energy source connected with the road finishing machine.

12. The road finishing machine according to claim 10, wherein the road finishing machine comprises a sensor for measuring an environmental parameter, and wherein the control unit is configured to determine the start time based on the measured environmental parameter.

13. The road finishing machine according to claim 10, wherein the control unit is configured to determine the start time based on a cooling parameter of the screed stored in a memory of the control unit.

14. The road finishing machine according to claim 10, wherein the control unit is configured to only activate the heating of the screed if the control unit receives a signal indicative of a positioning of a securing element.

15. The road finishing machine according to claim 14, wherein the securing element comprises a non-combustible material and/or a heat-insulating material.

16. The road finishing machine according to claim 10 wherein the control unit is configured to generate a control signal operative to activate automatic heating of the screed.

17. A road finishing machine comprising a screed and a control unit, wherein the control unit is configured to:
obtain a predetermined time for putting the screed into operation;
obtain a start time for beginning heating of the screed based on the predetermined time; and
generate a control signal operative to activate automatic heating of the screed by supply of energy from an energy source to a heating means of the screed from the start time.

18. The road finishing machine according to claim 17, wherein the start time is based on a measured cooling parameter and/or a measured heating parameter of the screed.

19. The road finishing machine according to claim 18, wherein the measured cooling parameter is determined by heating the screed to a predetermined test temperature and subsequently determining a parameter associated with a cooling of the screed, and/or wherein the measured heating parameter is determined by heating the screed to a predetermined test temperature and subsequently determining a parameter associated with the heating of the screed.

20. The road finishing machine according to claim 17, wherein the automatic heating of the screed is only activated by the control unit if the control unit receives a signal indicative of a positioning of a securing element.
